(19) United States
(12) Patent Application Publication
(10) Pub. No.: US 2012/0229663 A1
(43) Pub. Date: Sep. 13, 2012

(54) IMAGING SYSTEM HAVING PRIMARY AND AUXILIARY CAMERA SYSTEMS

(75) Inventors: Michael B. Nelson, Tucson, AZ (US); Michael D. Cable, Tucson, AZ (US)

(73) Assignee: SPECTRAL INSTRUMENTS IMAGING , LLC, Tucson, AZ (US)

(21) Appl. No.: 13/413,385

(22) Filed: Mar. 6, 2012

Related U.S. Application Data
(60) Provisional application No. 61/450,463, filed on Mar. 8, 2011.
(60) Provisional application No. 61/529,727, filed on Aug. 31, 2011.

(51) Int. Cl. H04N 5/225

(52) U.S. Cl. 348/220.1; 348/262; 348/E05.026

(57) ABSTRACT

An imaging system includes a main enclosure having at least one access door, the main enclosure defining a substantially light-tight imaging compartment when the access door is in a closed position. An object platform defining an image region therein is provided within the imaging compartment of the main enclosure. A primary camera positioned on a first side of the object platform is operable to capture a primary image of the image region on the object platform. An auxiliary camera positioned on the first side of the object platform is operable to produce an auxiliary image of the image region on the object platform.

### CROSS-REFERENCE TO RELATED APPLICATIONS

This application claims the benefit of U.S. Provisional Patent Application No. 61/450,463, filed on Mar. 8, 2011, and U.S. Provisional Patent Application No. 61/529,727, filed on Aug. 31, 2011, both of which are hereby incorporated herein by reference for all that they disclose.

### TECHNICAL FIELD

The present invention relates to imaging systems in general and more particularly to molecular imaging systems for use in bioluminescent and biofluorescent imaging applications.

### BACKGROUND

Molecular imaging systems are known in the art and are commonly used to capture various types or modes of images from an object or specimen being analyzed. The object or specimen that may be imaged may comprise any of a wide range of compositions, tissues, and animal specimens, as is well-known. Primarily, such imaging systems are configured to detect extremely low levels of light emitted by the object under study. The light emitted by the object may be generated by a bioluminescence process, a biofluorescence process, or by a combination of both. The resulting emitted light image may be used for any of a wide variety of purposes, including, for example, research studies relating to gene function and disease progression in living organisms.

Such imaging systems may also be capable of capturing reflected light images, in which light reflected by the object is captured by the imaging system camera. The reflected light image may then be used to correlate or compare certain features and attributes of the emitted light image with the external, physical configuration of the object shown in the reflected light image. Typically, the two types of images, i.e., the emitted and reflected light images, are combined with one another to form a combined or composite image. Such a composite image allows a user to more easily correlate features and attributes of the emitted light image(s) with physical locations on the object or other characteristics shown in the reflected light image. Generally speaking, such composite images are particularly useful when studying living organisms in-vivo, although they may be used when studying any type of object, either in-vivo or in-vitro.

### SUMMARY OF THE INVENTION

An imaging system includes a main enclosure having at least one access door, the main enclosure defining a substantially light-tight imaging compartment when the access door is in a closed position. An object platform defining an image region therein is provided within the imaging compartment of the main enclosure. A primary camera positioned on a first side of the object platform is operable to capture a primary image of the image region on the object platform. An auxiliary camera positioned on the first side of the object platform is operable to produce an auxiliary image of the image region on the object platform.

A method for capturing an image of an object according to one embodiment of the invention may include: Positioning the object on an object platform; capturing an auxiliary image of the object with an auxiliary camera; displaying the auxiliary image of the object on a display device; observing the auxiliary image of the object on the display device; and capturing a primary image of the object with a primary camera.

### BRIEF DESCRIPTION OF THE DRAWINGS

Illustrative and presently preferred exemplary embodiments of the invention are shown in the drawings in which:

FIG. 1 is a perspective view of an imaging system according to one embodiment of the present invention;

FIG. 2 is a sectional view in perspective of the imaging system illustrated in FIG. 1 revealing various internal components of the imaging system, including an interior imaging region, object platform, and camera support structure;

FIG. 3 is a bottom sectional view in perspective of the camera support structure showing one configuration of the primary camera and the auxiliary camera;

FIG. 4 is a composite image of well plate samples comprising reflected and emitted light images as it may be displayed on a display device;

FIG. 5 is an enlarged bottom sectional view in perspective of the camera support structure shown in FIG. 3 with the shield plates removed to more clearly show the various components of the gantry assembly;

FIG. 6 is a bottom sectional view in elevation of the camera support structure showing the auxiliary camera and gantry assembly;

FIG. 7 is a front view in elevation of the auxiliary camera and gantry assembly;

FIG. 8 is an enlarged perspective view of a light source assembly having an auxiliary camera mounted therein; and

FIG. 9 is a sectional view in elevation of the light source assembly of FIG. 8 more clearly showing the angled relationship between the axis of the auxiliary camera and the axis of the primary camera.

### DETAILED DESCRIPTION OF THE PREFERRED EMBODIMENTS

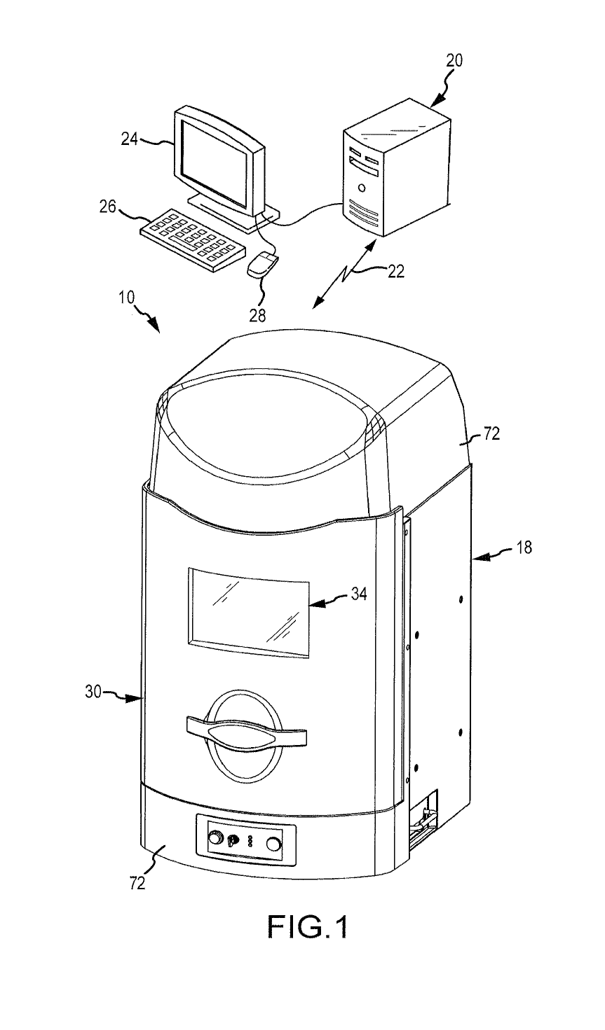

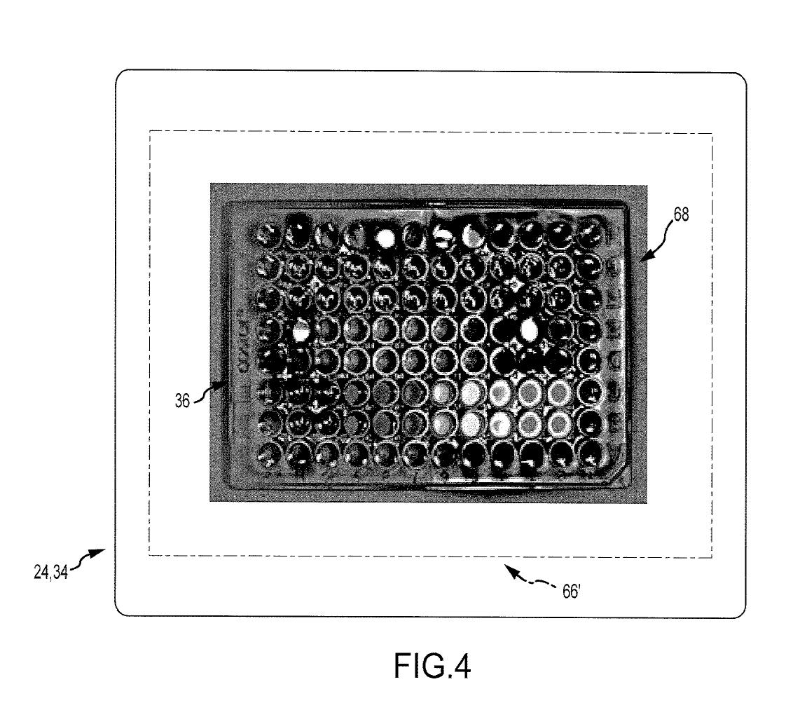

An imaging system 10 according to one embodiment of the present invention is illustrated in FIGS. 1-4 and is shown and described herein as it could be used in a molecular imaging application to capture one or more images 68 (FIG. 4) of an object 12 provided in the imaging system 10. As will be described in much greater detail herein, the imaging system 10 may comprise a main or primary camera 14 and an auxiliary camera 16. The main or primary camera 14 is capable of detecting extremely low levels of light that may be emitted by the object 12, typically via a bioluminescence process, a biofluorescence process, or by a combination thereof. The resulting emitted light image captured by the primary camera 14 may be used for any of a wide variety of purposes including, for example, research studies relating to gene function and disease progression in living organisms.

The auxiliary camera 16 may be used to capture reflected light images of the object 12. Such reflected light images may be used to correlate or compare certain features and attributes of the emitted light images with the external, physical configuration of object 12. The reflected light images may also be used to advantage in other situations and circumstances, many of which are described herein and others of which will become apparent to persons having ordinary skill in the art after having become familiar with the teachings provided herein.

Referring now primarily to FIG. 1-3, in one embodiment, the imaging system 10 may comprise a generally rectangularly-shaped chassis or main enclosure 18 that houses and supports the various components and subsystems required to perform various types of molecular imaging processes, including the in-vitro and in-vivo molecular imaging processes described herein. The imaging system 10 may be designed or configured to be connected to separate computer system 20, e.g., via a suitable data link 22. The computer system 20 may comprise a conventional “PC” type of computer system and may be provided with a display system 24, along with one or more input devices, such as a keyboard 26 and a mouse 28. The computer system 20 allows a user to operate the imaging system 10 and view images produced by the imaging system 10.

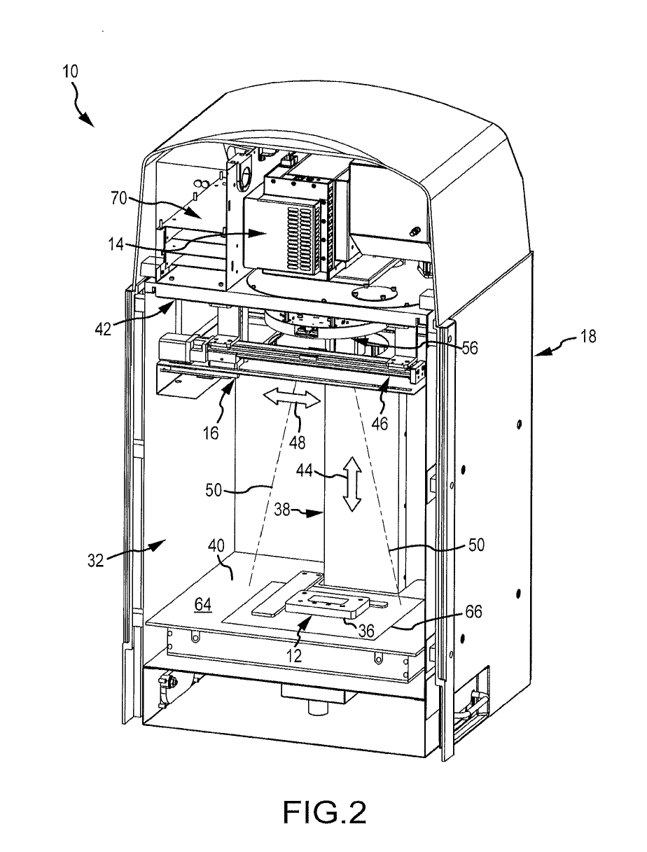

The main enclosure 18 of imaging system 10 may be provided with an access door 30 that can be moved vertically between a closed position (shown in FIG. 1) and an opened position (not specifically illustrated in the drawing figures) to allow the user to access an imaging compartment or chamber 32 defined by the main enclosure 18. See FIG. 2. In one embodiment, access door 30 may be provided with an auxiliary display system 34 that may be used to display various kinds of images produced by the imaging system 10. The imaging compartment 32 is sized to receive the object or objects 12 to be imaged. Objects 12 suitable for use with the imaging system 10 include samples that may be provided in a well plate 36 (e.g., for in-vitro imaging processes), as well as living organisms (not shown) (e.g., for in-vivo imaging processes).

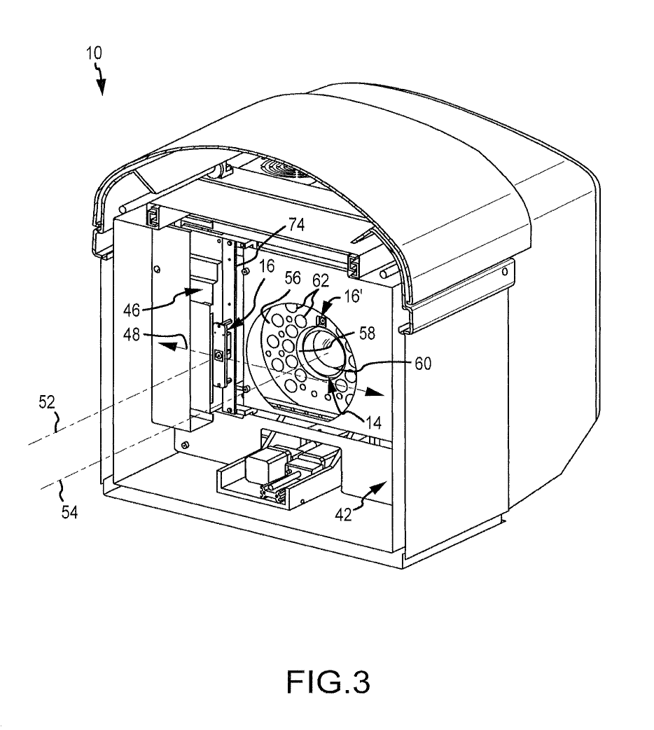

Referring now primarily to FIGS. 2 and 3, the imaging system 10 may include an imaging system sub-assembly 38 comprising an object platform or stage 40 as well as a mounting or camera support structure 42. The object platform 40 is moveably mounted to the sub-assembly 38 so that the object platform 40 can be moved vertically toward and away from the camera support structure 42, i.e., generally in the direction indicated by arrows 44. The moveable object platform 40 allows the primary and auxiliary cameras 14 and 16 to capture images of a desired portion or portions of the object 12.

The camera support structure 42 may be configured to receive or mount the primary camera 14 as well as the auxiliary camera 16, as best seen in FIG. 3. Camera support structure 42 may also mount a light source assembly 56. Light source assembly 56 may be provided with a central opening 58 therein that is sized to receive a lens assembly 60 of primary camera 14. Light source assembly 56 may comprise a plurality of light sources 62 suitable for illuminating the object 12 with light in various wavelength regions or bands, as will be described in further detail herein. Camera support structure 42 may also be configured to receive various other components and systems, including components of an image processing system 70, which may be required or desired for the operation of the imaging system 10.

The primary and auxiliary cameras 14 and 16 are mounted adjacent one another on a first side 64 (FIG. 2) of the object platform 40. In one embodiment, the auxiliary camera 16 is movably mounted to the camera support structure 42 so that the auxiliary camera 16 may be moved with respect to the primary camera 14 to an optimal position for capturing an auxiliary image. For example, in one embodiment, the auxiliary camera 16 may be mounted to a gantry assembly 46 that is in turn mounted to camera support structure 42. Gantry assembly 46 allows the auxiliary camera 16 to be moved along a longitudinal direction (indicated by arrows 48) between at least a first position (shown in FIGS. 2 and 3) and a second position (not specifically illustrated in the drawing figures), wherein the auxiliary camera 16 is generally aligned with primary camera 14. When moved to the first position, the auxiliary camera 16 will not substantially obstruct a field of view 50 (FIG. 2) of the primary camera 14. When moved to the second position, the auxiliary camera 16 will be substantially aligned with the primary camera 14, e.g., so that an image axis 52 of auxiliary camera 16 will be substantially aligned or coincident with an image axis 54 of primary camera 14.

The primary camera 14 of image system 10 may comprise a high-performance, high-sensitivity camera suitable for capturing the extremely low light intensities typically emitted by biofluorescent and bioluminescent objects 12. During operation, the light sensitive element (not shown) of the primary camera 14 may be cooled to very low temperatures to improve the sensitivity, dynamic range, and signal-to-noise ratio of the camera.

In contrast to the primary camera 14, the auxiliary camera 16 may comprise a general purpose electronic (e.g., CCD) camera of the type commonly used in cellular telephones and so-called “consumer grade” cameras. The auxiliary camera 16 may be used to capture an auxiliary image of the object 12 provided in the imaging compartment 32. In most embodiments, the auxiliary image produced by the auxiliary camera 16 will comprise a reflected light image of the object 12. The auxiliary camera 16 may be operated in a still picture mode and in a video image mode. When operated in the still picture mode, the auxiliary image captured by auxiliary camera 16 will comprise a still or non-moving image of the object 12. When operated in the video image mode, the auxiliary image captured by auxiliary camera 16 will comprise a video or moving picture image of the object 12.

The imaging system 10 may be operated as follows to capture various kinds of images of the object 12. A first step in the process may involve positioning the object 12 on the object platform or stage 40 (FIG. 2). This positioning step usually will be done with the access door 30 in the opened position. As such, the imaging compartment 32 and object 12 will be exposed to ambient light (e.g., from the exterior surroundings). If needed or desired, additional light may be provided by one or more of the light sources 62 of light source assembly 56. See FIG. 3. The ambient light and/or light provided by one or more of the light sources 62 is sufficient to allow the auxiliary camera 16 to capture an auxiliary image of the object 12 as it is being positioned on the object platform 40. The captured auxiliary image may be displayed on the display system 24 (FIG. 1) associated with the computer system 20. The captured auxiliary image may also be displayed on the auxiliary display 34 provided on access door 30.

At this point, the user may observe the auxiliary image on the display system(s) 24 and/or 34 to confirm that the object 12 is positioned at a desired location and orientation on the object platform 40. For example, the user can ensure that the object 12 is positioned within a preferred image region 66 (FIG. 2) on the object platform 40. If the object 12 is not properly positioned and/or oriented on the object platform 40 (e.g., by reference to display 24 and/or auxiliary display 34), the user may re-position the object 12 as necessary. The user may confirm proper object placement and/or orientation based on the auxiliary image presented on display system 24 and/or auxiliary display system 34. In an embodiment wherein the auxiliary camera 16 is operable in a video image mode, the auxiliary image displayed on the display system 24 and/or auxiliary display 34 may comprise a video image of the object 12. Operating the auxiliary camera 16 in the video image mode will allow the user to manually position the object 12 on the object platform 40 while simultaneously viewing the auxiliary video image provided on the display system 24 and/or auxiliary display system 34 provided on access door 30.

In one embodiment, the imaging system 10 is configured to display (i.e., on display systems 24 and/or 34) an image area outline 66′ along with the auxiliary image, as best seen in FIG. 4 (although a composite image 68 is shown in FIG. 4). The displayed image area outline 66′ may be configured so that it is substantially coincident with the preferred image region 66 (FIG. 2) on the image platform 40. Thus, the user will be able to position the object 12 with reference to the displayed image area outline 66′ displayed on the display system(s) 24, 34, as opposed to attempting to position and orient the object 12 by referring to marks or indications that might otherwise be provided on the object platform 40. Indeed, the ability of the present invention to display the image area outline on the display system(s) 24, 34 will eliminate the need to provide marks or indications on the object platform 40 to designate or outline the preferred image region 66.

Once the user has properly positioned, and, if necessary, re-positioned, the object 12 on the object platform 40, the access door 30 may be moved to the closed position. When the access door 30 is closed, the imaging compartment 32 will be substantially light-tight, thereby allowing the primary camera 14 to capture the extremely low-light (i.e., emitted light image) produced by the bioluminescent and/or biofluorescent object 12. If the object is bioluminescent, then the primary camera 14 may directly capture an emitted light image of the object 12 by opening a shutter (not shown) on the primary camera 14 for a time sufficient to capture the desired low-light bioluminescent image. Alternatively, if a biofluorescent image of the object 12 is to be captured, then the fluorescent material(s) in the object 12 will first need to be activated or excited. In one embodiment, the excitation of the biofluorescent material in the object 12 may be activated or excited by illuminating the object 12 with excitation light of the appropriate wavelength, which may be provided by one or more of the light sources 62 provided in light source assembly 56. After an appropriate period of time, the excitation light source(s) 62 may be extinguished. An emitted light image of the now biofluorescing object 12 then may be captured by the primary camera 14.

The primary (i.e., emitted light) image(s) captured by the primary camera 14 may be displayed on display system 24. Such images may also be displayed on the auxiliary display system 34, if desired. At some point during the imaging process, e.g., either before or after the capture of the emitted light image by the primary camera 14, the imaging system 10 may activate the auxiliary camera 16 to capture an auxiliary image of the object 12. In many cases, the auxiliary image captured by the auxiliary camera 16 will comprise a reflected light “still” image of the object 12, as opposed to a video image. Moreover, such an auxiliary image usually will be captured with the access door 30 still in the closed position. Light sufficient for illuminating the object 12 may be provided by activating one or more of the light sources 62 comprising light source assembly 56. The auxiliary image from the auxiliary camera 16 can then be combined with the primary image from the primary camera 14 to produce a composite image 68, i.e., an image comprising both the emitted and reflected light images of the object 12, as best seen in FIG. 4. The composite image 68 may be displayed on either or both of the displays 24 and 34.

In some embodiments (e.g., wherein the auxiliary camera 16 is displaced from the primary camera 14, as described below), it may be necessary or desirable to transform the auxiliary image so that it is in substantial registration with the primary image. If so, image processing system 70 may use one or more image transformation techniques to transform the auxiliary image data so that features thereof are in substantial registration with corresponding features in the primary image data.

Significant advantages and beneficial features of the imaging system 10 according to the present invention are associated with the provision of the primary and auxiliary cameras 14 and 16. For example, the provision of the auxiliary camera 16 allows a user to readily confirm (i.e., by viewing displays 24 and/or 34) that the object 12 has been properly positioned and oriented on the image platform 40 without the need to activate the primary camera 14. Moreover, in an embodiment wherein the auxiliary camera 16 may be operated in a video image mode, the user may position and orient the object 12 on the object platform 40 with reference to a real-time video image provided on the display device(s) 24 and/or 34. Generally speaking, the presentation of such a real-time video image on the auxiliary display device 34 provided on the access door 30 will allow the user to rapidly position (or re-position) the object 12 on the object platform 40 by simply viewing the video image presented on auxiliary display system 34. That is, the auxiliary display system 34 will be in a convenient position for the user during the object positioning step. Still further, in an embodiment wherein the system 10 is configured to display an image area outline 66′ (FIG. 4) along with the video image, the user may easily and rapidly position the object 12 at a desired location and in a desired orientation on the object platform 40, all by simply referencing the real-time video image and image area outline 66′ provided on the display system 24 and/or auxiliary display system 34.

The provision of the imaging system 10 with both the primary and auxiliary cameras 14 and 16 provides yet other significant advantages not recognized in the art. For example, conventional imaging systems use the primary camera to capture or take both emitted light and reflected light images of the object. However, the primary camera is ill-suited to capture reflected light images, primarily because of the high light levels typically involved. Even if care is taken to ensure that the ambient light levels are sufficiently low, the light levels involved may still impair the ability of the primary camera to subsequently capture high quality emitted light images of the object.

More specifically, the high-performance, high-sensitivity cameras used by such conventional imaging systems are highly sensitive to a so-called residual or latent image phenomenon when exposed to high light levels, either within a localized region of the light sensor or over its entire area. The residual or latent image phenomenon not only degrades the current image, but also results in the formation of a residual image that appears in subsequent images captured by the camera. In extreme cases, it may be necessary to deactivate the camera cooling system and allow the image sensor to warm in order to dissipate the latent image. Obviously, such a remedy is less than desirable in day-to-day operations of such devices.

Because the residual or latent image problem is currently viewed as inherent in such systems, manufacturers typically select primary cameras that have the most favorable performance specifications relating to the latent image phenomenon, commonly referred to as a latent image specification. Significantly, however, not all light sensors manufactured by a given fabrication process have the same latent image specification. Thus, in conventional systems it is necessary to select only those image sensors having the best latent image specifications. A significant advantage of the present invention is that the imaging system 10 does not require a primary camera 14 having such a favorable latent image specification, thereby allowing a wider range of primary cameras to be used. Stated another way, because the primary camera 14 of the present invention need not be used to capture a reflected light image of the object 12, the latent image specification of the primary camera 14 may be considerably relaxed compared to those required for conventional imaging systems.

Still further, and as discussed above, the provision of an auxiliary camera 16 that can be operated in both a video image mode and a still picture mode provides additional advantages. For example, operating the auxiliary camera 16 in the video image mode allows the user to observe the position and orientation of the object 12 in real-time simply by observing the video image presented on the display 24 and/or the auxiliary display 34. The ability to display such video images provides significant advantages over conventional systems because the primary cameras thereof cannot be operated in a video image mode. Even if they could, there is still a concern about operating the primary camera in circumstances involving high light levels, such as when the door 30 is open.

Yet other advantages of the present invention are associated with the display of the image area outline 66′ along with the video image provided by the auxiliary camera 16. As mentioned, the displayed image area outline 66′ allows the user to readily confirm that the object 12 is positioned at the desired location on the object platform 40. Therefore, the object platform 40 itself need not be provided with an indication of the boundaries of the preferred image region 66. Still further, because most such indications are typically provided by paints or dyes (for easy recognition by the user), there is no need to avoid the use of paints or dyes that may be luminescent or fluorescent. With the present invention, there is no need to provide such an indication on the object platform 40.

Still yet other advantages are associated with the movable mounting arrangement for the auxiliary camera 16. For example, the ability to move the auxiliary camera 16 to the second position (i.e., wherein the image axis 52 of auxiliary camera 16 is substantially aligned with the image axis 54 of primary camera 14) simplifies subsequent image processing steps. Moreover, the ability to move the auxiliary camera 16 in the longitudinal direction 48 allows the auxiliary camera 16 to be conveniently moved out of the field of view 50 of primary camera 14 when primary camera 14 is to be used.

Having briefly described one exemplary embodiment of an illumination system 10 according to the present invention, as well as some of its more significant features and advantages, various embodiments of the illumination system 10 will now be described in detail.

Referring back now to FIGS. 1-3, the imaging system 10 may comprise a generally rectangularly-shaped chassis or main enclosure 18 that houses and supports the various components and subsystems required to perform various types of molecular imaging processes. In one embodiment, the main enclosure 18 is provided with various external finish panels 72 that cover or overlay the main enclosure 18, although such finish panels 72 are not required. In the particular embodiment shown and described herein, the imaging system 10 is configured to be operatively connected to separate computer system 20 via a suitable wired or wireless data link 22. Alternatively, of course, other configurations are possible, as would become apparent to persons having ordinary skill in the art after having become familiar with the teachings provided herein. Consequently, the present invention should not be regarded as limited to any particular configuration.

Computer system 20 may comprise a conventional “PC” type of computer system and may be provided with a display system 24, along with one or more input devices, such as a keyboard 26 and a mouse 28. The computer system 20 may be provided with one or more software packages or computer programs that allow the computer system 20 to interface with the imaging system 10. The computer program(s) may be configured to allow the computer 20 to control various functions and operations of the imaging system 10. In addition, the computer programs may be configured to perform various image processing functions to allow the various primary and auxiliary images to be displayed on display system(s) 24, 34 in the manner described herein. Alternatively, some or all of the image processing may be performed by the image processing system 70 contained within main enclosure 18.

Software suitable for providing the functionality described herein may be readily provided by persons having ordinary skill in the art after having become familiar with the teachings provided herein. Consequently, the particular computer programs or software packages that may be provided to computer system 20 will not be described in further detail herein, other than to note those functions and processes that may be implemented thereby.

As briefly described above, the main enclosure 18 of imaging system 10 may be provided with an access door 30 that can be moved vertically between a closed position (shown in FIG. 1) and an opened position (not specifically illustrated in the drawing figures). The access door 30 allows the user to access the imaging compartment or chamber 32 defined by the main enclosure 18, e.g., to position the desired object 12 therein. When the access door 30 is closed, the imaging compartment 32 will be substantially light-tight. As briefly described above, objects 12 suitable for use with the imaging system 10 include samples that may be provided in a well plate 36, i.e., for in-vitro imaging processes. The objects 12 may also comprise living organisms, such as animals (not shown), i.e., for in-vivo imaging processes.

In one embodiment, the access door 30 may be provided with an auxiliary display system 34, as best seen in FIG. 1. The auxiliary display system 34 may be operatively connected to the computer system 20 and/or image processing system 70. Computer system 20 and/or image processing system 70 may be programmed or operated to display various images on the various display systems 24 and 34. For example, in many embodiments it will be desirable or advantageous for the computer system 20 to display the images captured by the auxiliary camera 16 on the auxiliary display system 34. That is, because the auxiliary display system 34 is provided on access door 30 it will be in an ideal position for a user positioning the object 12 on the object platform 40. The user will be able to position the object 12 in the desired position on the object platform 40 without straining to see the other display system 24, which might be located a significant distance from the imaging system 10 or otherwise not readily observable by the user during the object positioning sequence.

In the particular embodiment shown and described herein, the imaging system 10 may include an imaging system sub-assembly 38 comprising an object platform or stage 40 as well as a mounting or camera support structure 42, as best seen in FIG. 2. The object platform 40 may be moveably mounted to the sub-assembly 38 so that the object platform 40 may be moved vertically toward and away from the camera support structure 42, generally in the direction indicated by arrows 44. The moveable object platform 40 allows the primary and auxiliary cameras 14 and 16 to capture images of a desired portion or portions of the object 12 provided on the object platform 40.

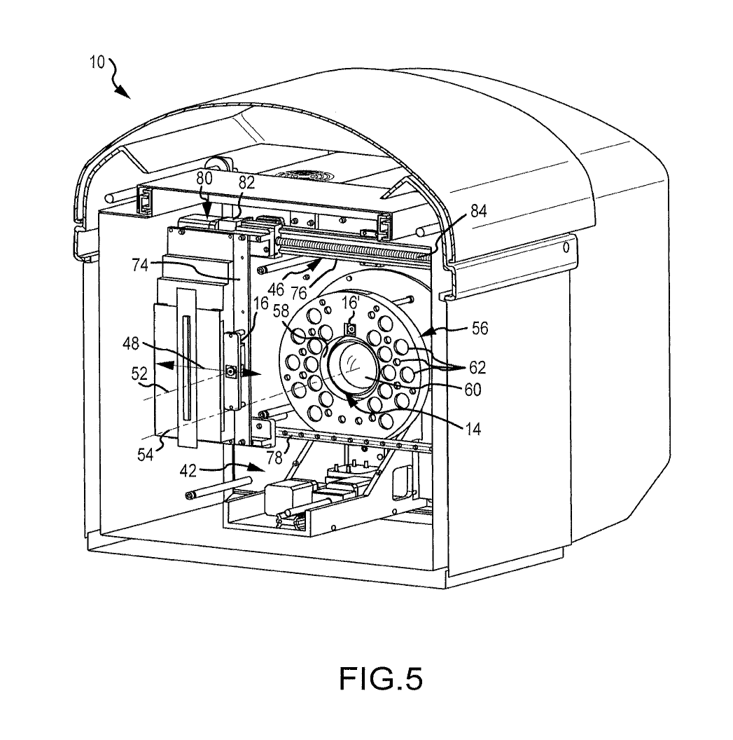

The camera support structure 42 may also mount a light source assembly 56. In the particular embodiment shown and described herein, light source assembly 56 may comprise a generally round or circular structure defining a central opening 58 therein that is sized to receive a lens assembly 60 of primary camera 14, in the manner best seen in FIG. 5.

Light source assembly 56 may comprise a plurality of light sources 62 suitable for illuminating the object 12 with light in various wavelength regions or bands. More specifically, the light sources 62 may be used to produce excitation light of a wavelength range suitable for exciting the particular fluorescent material in the object 12 to be imaged. Because the imaging system 10 is designed or configured to image a wide variety of fluorescent materials, each of which may require excitation light of a different wavelength or wavelengths, each of the light sources 62 of light source assembly 56 produces light in a different wavelength range. Accordingly, a wide range of fluorescent materials may be excited or made to fluoresce by simply activating the particular light source or sources 62 that produce light in a wavelength range suitable for exciting the particular fluorescent material to be imaged. In the embodiment shown and described herein, at least one of the light sources 62 may comprise a broad-band (e.g., white light) source suitable for illuminating the object 12. So illuminating the object 12 with a broad-band or white light source will allow the auxiliary camera 16 to capture a true color reflected light image of the illuminated object 12, if desired.

Camera support structure 42 may also be configured to receive various other components and systems (e.g., motor and camera control systems as well as a cooling system for the primary camera 14) required to capture various kinds of images (e.g., emitted and reflected light images) of the object 12. However, because a detailed description of such other components and systems is not required to understand and practice the current invention, the particular components and systems that may also be provided to the imaging system 10 will not be described in further detail herein.

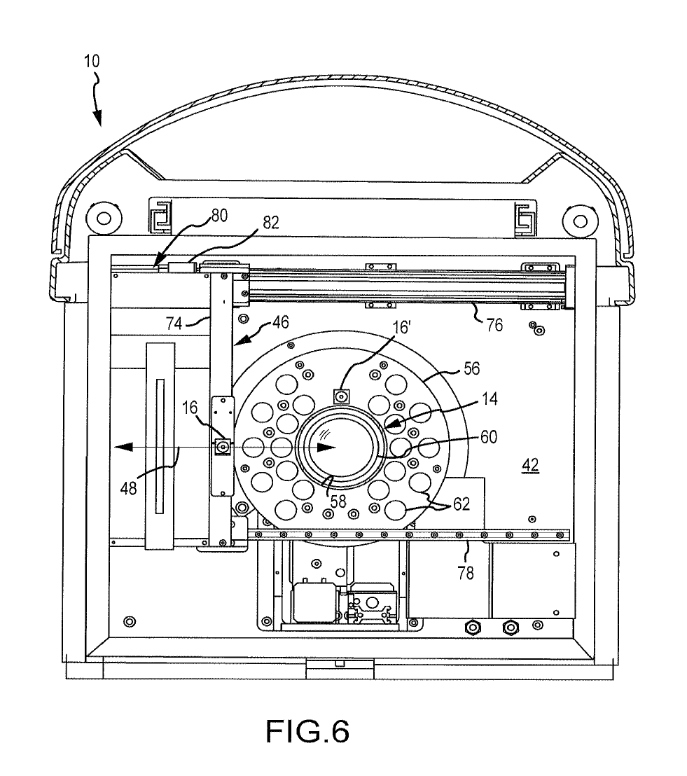

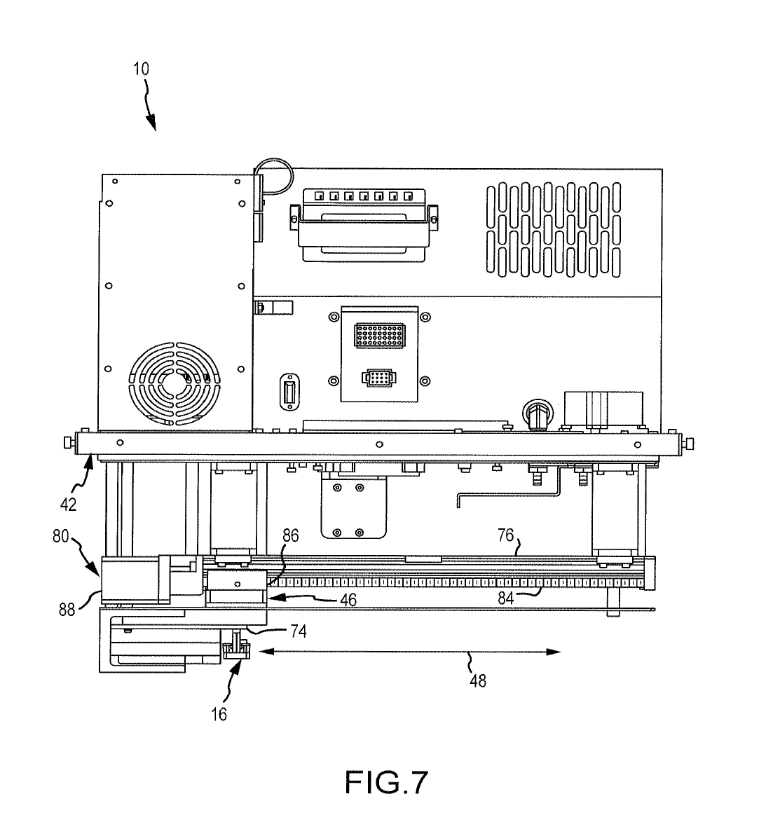

Referring now to FIGS. 3 and 5-7, the auxiliary camera 16 may be moveably mounted to camera support structure 42 by means of gantry assembly 46. Gantry assembly 46 allows the auxiliary camera 16 to be translated or moved along longitudinal direction 48, as best seen in FIGS. 2, 3, and 5. The degree of movement should be sufficient so that when auxiliary camera 16 is located in a first or stowed position (illustrated in FIGS. 2, 3, and 5), it does not substantially obstruct the field of view 50 of primary camera 14. Similarly, the degree of movement along longitudinal direction 48 should be sufficient to allow the auxiliary camera 16 to be moved to a position wherein the auxiliary camera 16 is aligned with the primary camera 14, i.e., so that the image axis 52 of auxiliary camera 16 is substantially aligned with the image axis 54 of primary camera 14. In one embodiment, the degree of movement provided by the gantry assembly 46 is sufficient to allow the auxiliary camera 16 to be moved to a third position (also not shown in the drawing figures) on the opposite (i.e., right-hand) side of the lens assembly 60 of primary camera 14. See FIG. 6. When moved to the third position, the auxiliary camera 16 will also not substantially obstruct the field of view 50 of primary camera 14. However, the gantry assembly 46 need not be designed or configured to move the auxiliary camera 16 to such a third position.

Referring now primarily to FIGS. 5-7, gantry assembly 46 may comprise a transverse support member 74 that is moveably mounted to a pair of guide members or guide rails 76, 78. Guide rails 76, 78 may be mounted to camera support structure 42 so that they are located in generally parallel, spaced-apart relation. An actuator system 80 operatively associated with the auxiliary camera 16 is used to move or translate the auxiliary camera 16 along the guide rails 76, 78, between at least the first and second positions in the manner described herein. The actuator system 80 may also comprise a position sensor 82 that is operatively associated with the auxiliary camera 16. The position sensor 82 senses a longitudinal position of the auxiliary camera 16 along the guide rails 76, 78.

In one embodiment, the actuator system 80 comprises a lead screw 84 mounted for rotation on guide rail 76. A lead screw follower or nut assembly 86 mounted to the transverse support member 74 (to which is mounted auxiliary camera 16) and engaged with lead screw 84 moves the auxiliary camera 16 along the guide rails 76, 78 (i.e., in longitudinal direction 48) in response to rotation of the lead screw 84. A drive motor 88 operatively connected to lead screw 84 rotates lead screw 84, thereby causing the auxiliary camera 16 to move along the guide rails 76, 78 in the longitudinal direction 48 in the manner already described.

The position sensor 82 may comprise a rotary encoder (not shown) operatively connected to the lead screw 84 that produces an output signal relating to the rotation of the lead screw 84. Alternatively, a linear encoder or sensor may be used to sense linear movement or translation of the auxiliary camera 16 along the guide rails 76, 78.

When it is desired to capture an image with auxiliary camera 16, the actuator system 80 may be operated to move auxiliary camera 16 along gantry assembly 46 until auxiliary camera 16 is substantially aligned with primary camera 14, i.e., so that the image axis 52 of auxiliary camera 16 is substantially aligned with image axis 54 of primary camera 14. Auxiliary camera 16 may then be used to capture auxiliary images. When the auxiliary camera 16 is no longer needed, the actuator system 80 may again be operated to move the auxiliary camera 16 along the gantry assembly 46 until it is at a position that will not substantially obstruct the field of view 50 (FIG. 2) of primary camera 14.

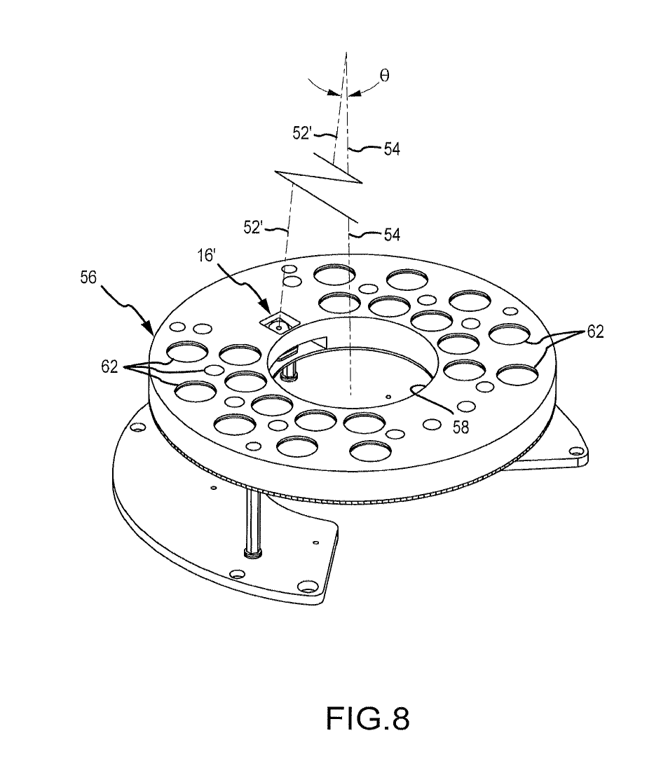

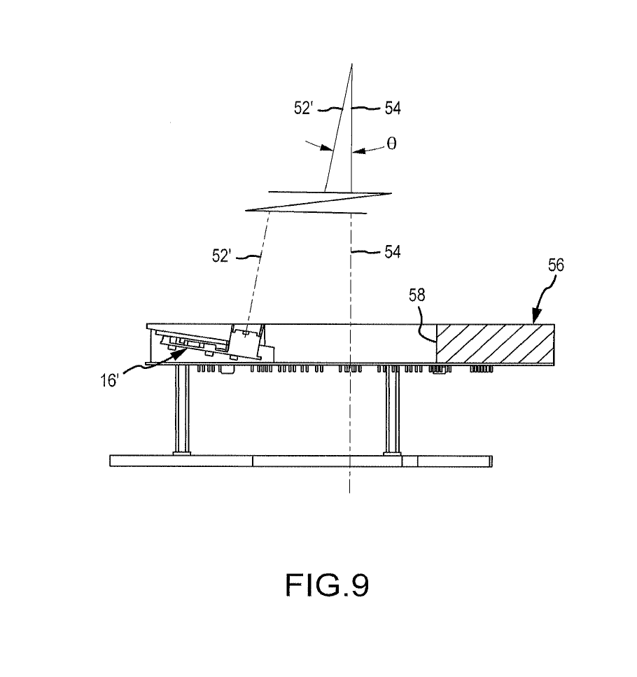

Other mounting arrangements for the auxiliary camera 16 are possible. For example, another embodiment may mount an auxiliary camera 16′ to the light source assembly 56, as best seen in FIGS. 5, 6, 8, and 9. In such an embodiment, the auxiliary camera 16′ may replace, or may be used in conjunction with, the movable auxiliary camera 16. However, in such an embodiment, the image axis 52′ of the auxiliary camera 16′ will be displaced from the image axis 54 of primary camera 14, as best seen in FIGS. 8 and 9. Still further, and in an embodiment wherein the primary camera 14 is positioned and oriented so that its image axis 54 is generally orthogonal to a preferred image region 66 (FIG. 2) on object platform 40, the image axis 52′ of auxiliary camera 16′ will be inclined by an angle θ with respect to image axis 54 of primary camera 14. The angle of inclination θ between the two image axes 52′ and 54 may be helpful in transforming the image data produced by the auxiliary camera 16′ so that the auxiliary image can be made to be in substantial registration with the primary image captured by primary camera 14.

The primary camera 14 of image system 10 may comprise any of a wide range of high-sensitivity cameras that are now known in the art or that may be developed in the future that are or would be suitable for capturing the extremely low light intensities associated with bioluminescent and/or biofluorescent objects 12. Consequently, the present invention should not be regarded as limited to any particular primary camera 14. Moreover, and as discussed above, a significant advantage of the present invention is that it will allow primary cameras 14 having lowered or relaxed latent image specifications to be used, in that the primary camera 14 need not be used to capture reflected light images of the object. Cameras suitable for use as the primary camera 14 may be obtained from Spectral Instruments, Inc., of Tucson, Ariz.

Auxiliary camera 16 (and/or auxiliary camera 16′) may comprise any of a wide range of cameras suitable for providing the desired image functionality. For example, it is generally preferred, but not required, that the auxiliary camera 16 be operable in both a still picture mode and in a video image mode. Operation of the auxiliary camera 16 in the video image mode will allow a video image to be displayed on the display system(s) 24 and/or 34 while the user is placing the object 12 on the object platform 40. The user will then be able to view the placement of the object 12 in real time. The auxiliary camera 16 may later be operated in the still picture mode to capture a reflected image of the object 12 suitable for combination with the emitted light image captured by the primary camera 14.

In accordance with the foregoing considerations, then, the auxiliary camera 16 may comprise any of a wide range of cameras that are now known in the art or that may be developed in the future that are, or would be, suitable for providing the desired functionality and for the particular application. Consequently, the present invention should not be regarded as limited to any particular type of camera. By way of example, in one embodiment, the auxiliary camera 16 comprises a CCD camera of the type commonly used in cellular telephones.

The imaging system 10 may be operated as follows to capture various kinds of images, particularly low-light or emitted light images of the object 12. In a first step, the user may position the object 12 on the object platform 40 (FIG. 2). This positioning step will be done with the access door 30 in the opened position. The imaging compartment 32 and object or specimen 12 will, therefore, be exposed to considerable levels of ambient light. In many instances, the ambient light from the opened door 30 will provide sufficient illumination to allow the auxiliary camera 16 to produce an auxiliary image satisfactory for display on display device 24 and/or auxiliary display device 34. However, if required or desired, additional light may be provided by activating one or more of the light sources 62 (FIGS. 3 and 5) provided in the light source assembly 56, as described above. The ambient light and/or light provided by one or more of the light sources 62 allows the auxiliary camera 16 to capture an auxiliary image of the object 12 as it is being positioned on the object platform 40. The captured auxiliary image may be displayed on the display system 24 associated with the imaging system 10. The captured auxiliary image may also be displayed on the auxiliary display system 34 provided on access door 30. See FIG. 1.

At this point, the user may observe the auxiliary image on the display system 24 and/or auxiliary display system 34 to confirm that the object 12 is positioned at a desired location and in a desired orientation on the object platform 40. For example, the user can ensure that the object 12 is positioned within the preferred image region 66 (FIG. 2) on the object platform 40. If the object 12 is not properly positioned and/or oriented, the user may re-position the object 12 as necessary. The user may confirm proper object placement and/or orientation based on the displayed auxiliary image captured by the auxiliary camera 16 and presented on auxiliary display system 34 and/or the display system 24. If the auxiliary camera 16 is operable in a video image mode, then the auxiliary image displayed on the auxiliary display system 34 (and/or display system 24) may comprise a video image of the object 12. Operating the auxiliary camera 16 in the video image mode will allow the user to manually position the object 12 on the object platform 40 while simultaneously viewing the auxiliary video image provided on the display system(s) 24 and/or 34.

In one embodiment, the imaging system 10 is configured to display an image area outline 66′ on the display system 24 and/or auxiliary display system 34 along with the auxiliary image, as best seen in FIG. 4 (although the image shown in FIG. 4 is a composite image 68). The image area outline 66′ is configured so that it substantially coincides with the preferred image region 66 (FIG. 2) on the image platform 40. In this regard it should be noted that the preferred image region 66 need not be designated by actual markings provided on the object platform 40, in that materials used to make such markings (e.g., paints and dyes) will typically fluoresce, thereby interfering with the low light image captured by the primary camera 14. The provision of the image area outline 66′ on the display system(s) 24, 34 thereby allows the user to position the object 12 with reference to the image area outline 66′ provided on the display system(s) 24, 34, rather than by attempting to discern the preferred image region 66 that may be provided on the object platform 40.

Once the user has properly positioned, and, if necessary, re-positioned, the object 12 on the object platform 40, the access door 30 may be moved to the closed position. When the access door 30 is closed, the imaging compartment 32 will be substantially light-tight, thereby allowing for the capture of the extremely low-light (i.e., emitted light image) produced by the bioluminescent and/or biofluorescent object 12. If the object 12 is bioluminescent, then the primary camera 14 may immediately capture an emitted light image of the object 12 by opening a shutter (not shown) on the primary camera 14 for a time sufficient to capture the desired low-light bioluminescent image. Alternatively, if the object 12 is biofluorescent, then the fluorescent material(s) in the object 12 may first be activated or excited by illuminating the object 12 with excitation light of the appropriate wavelength. In the particular embodiment shown and described herein, the excitation light may be provided by one or more of the light sources 62 of light source assembly 56, as best seen in FIGS. 3 and 5. Thereafter, the excitation light source(s) 62 may be extinguished, and an emitted light image of the fluorescing object 12 captured by opening the shutter on the primary camera 14 for a sufficient time.

The primary (i.e., emitted light) images captured by the primary camera 14 may be displayed on display system 24 and/or auxiliary display system 34. At some point during this process, e.g., either before or after the capture of the emitted light image, the imaging system 10 may capture an auxiliary image of the object 12. Generally speaking, the auxiliary image will comprise a reflected light “still” image of the object 12. The auxiliary image may be captured with the access door 30 still in the closed position. Light sufficient for illuminating the object 12 may be provided by activating one or more of the light sources 62 of light source assembly 56.

The auxiliary image from the auxiliary camera 16 may comprise a color image and may be displayed on display system(s) 24, 34 as a color image. Alternatively, the image from the auxiliary camera 16 may be converted into a grayscale image before it is displayed on the display system(s) 24, 34. Generally speaking, it will be desirable to convert the auxiliary image to a grayscale image so that color renditions thereof do not interfere with the emitted light image, which typically comprises a “false color” image to more readily depict the variations in intensity levels of the emitted light image.

As mentioned above, the auxiliary image from the auxiliary camera 16 may also be combined with the primary image from the primary camera 14 (e.g., by an image processing system 70 and/or as may be implemented in software running on computer system 20) to produce a composite image 68, i.e., an image comprising both the emitted and reflected light images of the object 12. See FIG. 4.

In an embodiment wherein the auxiliary camera 16 is displaced from the primary camera 14, the image processing system 70 may be configured to first transform the auxiliary image so that it is in substantial registration with the primary image. Techniques and processes for conducting such image transformations are well-known in the art and could be readily provided by persons having ordinary skill in the art after having become familiar with the teachings provided herein. For example, in one embodiment, a suitable transfer function may be arrived at or developed by placing a calibration grid on the object platform 40. Images of the calibration grid may then be captured by both the primary camera 14 and the auxiliary camera 16. The image processing system may then transform or “warp” the auxiliary image to the corresponding primary image by correlating the corresponding grid locations and features from the two images. The developed transfer functions may then be used by the image processing system to transform subsequent auxiliary images so that they are in substantial registration with the primary images captured by primary camera 14.

Having herein set forth preferred embodiments of the present invention, it is anticipated that suitable modifications can be made thereto which will nonetheless remain within the scope of the invention. The invention shall therefore only be construed in accordance with the following claims:

1. An imaging system, comprising:
a main enclosure having at least one access door, said main enclosure defining a substantially light-tight imaging compartment when the access door is in a closed position;
an object platform provided within the imaging compartment of said main enclosure, said object platform including an image region;
a primary camera positioned on a first side of said object platform, said primary camera being operable to capture a primary image of the image region on said object platform; and
an auxiliary camera positioned on the first side of said object platform, said auxiliary camera being operable to produce an auxiliary image of the image region on said object platform.

2. The imaging system of claim 1, wherein said auxiliary camera is operable in a still picture mode and a video image mode, said auxiliary camera producing a still picture image of the image region on said object platform when operated in the still picture mode, said auxiliary camera producing a video image of the image region on said object platform when operated in the video image mode.

3. The imaging system of claim 1, further comprising:
an image processing system operatively associated with said primary and auxiliary cameras, said image processing system receiving image data from said primary and auxiliary cameras, said image processing system being operable to produce a composite image from the image data received from said primary and auxiliary cameras; and
a display system operatively associated with said image processing system, said display system displaying images from said image processing system.

4. The imaging system of claim 3, wherein said image processing system transforms image data from said auxiliary camera so that image data from said first auxiliary camera is in substantial registration with image data from said primary camera.

5. The imaging system of claim 1, wherein an image axis of said auxiliary camera is displaced from an image axis of said primary camera.

6. The imaging system of claim 5, wherein the image axis of said auxiliary camera is not parallel to the image axis of said primary camera.

7. The imaging system of claim 5, wherein the image axis of said primary camera is generally orthogonal to the image region on said object platform and wherein the image axis of said auxiliary camera is not orthogonal to the image region on said object platform.

8. The imaging system of claim 1, wherein said auxiliary camera is mounted at a position adjacent said primary camera.

9. The imaging system of claim 1, further comprising an auxiliary display system mounted to said main enclosure.

10. The imaging system of claim 9, wherein said auxiliary display system is mounted to the access door of said main enclosure.

11. The imaging system of claim 3, further comprising an auxiliary display system operatively associated with said image processing system, said auxiliary display system being mounted to said main enclosure.

12. The imaging system of claim 11, wherein said auxiliary display system is mounted to the access door of said main enclosure.

13. The imaging system of claim 1, wherein said auxiliary camera is moveable across a field of view of said primary camera from a first position to a second position, said second position substantially aligning an image axis of said auxiliary camera with an image axis of said primary camera.

14. The imaging system of claim 13, further comprising a gantry assembly mounted to said imaging system and wherein said auxiliary camera is mounted to said gantry assembly so that said auxiliary camera is moveable along said gantry assembly in a longitudinal direction.

15. The imaging system of claim 14, wherein said gantry assembly further comprises:
a first guide rail mounted to said imaging system so that said first guide rail extends along the longitudinal direction; and
a second guide rail mounted to said imaging system, said second guide rail being in generally parallel, spaced-apart relation to said first guide rail.

16. The imaging system of claim 15, further comprising an actuator system operatively associated with said gantry assembly and said auxiliary camera, said actuator system operable to move said auxiliary camera along said gantry assembly from the first position to the second position.

17. The imaging system of claim 16, wherein said actuator system comprises:
a lead screw mounted for rotation with respect to said second guide rail;
a lead screw follower engaged with said lead screw and slidably mounted to said second guide rail, said lead screw follower also being mounted to said auxiliary camera; and
a motor operatively associated with said lead screw, said motor rotating said lead screw.

18. The imaging system of claim 14, further comprising a position sensor operatively associated with said auxiliary camera and said gantry assembly, said position sensor sensing a position of said auxiliary camera along the longitudinal direction.

19. A method for capturing an image of an object, comprising:
positioning the object on an object platform;
capturing an auxiliary image of the object with an auxiliary camera;
displaying the auxiliary image of the object on a display device;
observing the auxiliary image of the object on the display device; and
capturing a primary image of the object with a primary camera.

20. The method of claim 19, further comprising confirming that the object is positioned at a desired location and in a desired orientation on the object platform based on the displayed auxiliary image of the object before said capturing the primary image of the object.

21. The method of claim 20, further comprising re-positioning the object on the object platform before capturing the primary image of the object.

22. The method of claim 19, wherein capturing the auxiliary image of the object comprises capturing a still image of the object and wherein displaying comprises displaying the still image of the object on the display device.

23. The method of claim 19, wherein capturing the auxiliary image of the object comprises capturing a video image of the object, and wherein displaying comprises displaying the video image of the object on the display device.

24. The method of claim 23, further comprising re-positioning the object on the object platform while viewing the video image of the object on the display device until the object is positioned at a desired location and in a desired orientation on the object platform.

25. The method of claim 19, further comprising transforming the auxiliary image to produce a transformed auxiliary image so that the transformed auxiliary image will be in substantial registration with the primary image.

26. The method of claim 15, further comprising displaying a composite image of the object on the display device, the composite image comprising an overlay of the transformed auxiliary image and the primary image.

27. The method of claim 25, wherein said transforming comprises comparing image data produced by the auxiliary camera with image data produced by the primary camera to develop a transfer function, the transfer function being used to transform the auxiliary image so that it is in substantial registration with the primary image.

28. The method of claim 19, further comprising converting the auxiliary image into a grayscale image before said displaying.

29. The method of claim 19, wherein displaying the auxiliary image of the object on the display device also comprises displaying an image area outline on the display device, said image area outline providing a visual indication of a preferred position of the object on the object platform.

30. The method of claim 19, wherein said capturing an auxiliary image comprises moving the auxiliary camera with respect to the primary camera so that the auxiliary camera is substantially aligned with the primary camera.

31. The method of claim 30, wherein said moving comprises moving the auxiliary camera so that an image axis of the auxiliary camera is substantially aligned with an image axis of the primary camera.

32. The method of claim 30, further comprising moving the auxiliary camera with respect to the primary camera after said capturing an auxiliary image.

33. The method of claim 32, wherein said moving the auxiliary camera with respect to the primary camera after said capturing an auxiliary image comprises moving the auxiliary camera so that it does not substantially obstruct a field of view of the primary camera.
